(19) United States
(12) Patent Application Publication
(10) Pub. No.: US 2015/0121294 A1
(43) Pub. Date: Apr. 30, 2015

(54) ELECTRONIC DEVICE AND METHOD FOR STARTING APPLICATION OF ELECTRONIC DEVICE

(71) Applicant: HON HAI PRECISION INDUSTRY CO., LTD., New Taipei (TW)

(72) Inventor: PING-CHU TSAI, New Taipei (TW)

(21) Appl. No.: 14/526,481

(22) Filed: Oct. 28, 2014

(30) Foreign Application Priority Data
Oct. 29, 2013 (TW) 102139169

(51) Int. Cl. G06F 3/0484; G06F 3/0482; G06F 3/0481

(52) U.S. Cl. CPC G06F 3/0484; G06F 3/04817; G06F 3/0482
USPC 715/780

(57) ABSTRACT

An electronic device includes a number of applications each having an icon and a character. The electronic device obtains at least one character and seeks a corresponding application according to the obtained character. When the corresponding application has been sought, a display of the electronic device displays the icon of the corresponding application. The electronic device determines whether one icon is chosen or not. When an icon is chosen, the electronic device starts the corresponding application of the chosen icon.

### CROSS-REFERENCE TO RELATED APPLICATIONS

1. Field

The present disclosure relates to an electronic device and a method for starting an application of the electronic device.

2. Background

In general, an electronic device includes a number of applications. Each application has a corresponding icon for a user to start the application. With an increase in the number of the applications of the electronic device, the user needs increasingly more time to find a specific application.

### BRIEF DESCRIPTION OF THE DRAWINGS

Implementations of the present disclosure will now be described, by way of example only, with reference to the attached figures.

FIG. 1 is a block diagram of one embodiment of an electronic device including an application starting system.

FIGS. 2-4 are diagrammatic views of a touch screen of the electronic device of FIG. 1.

FIG. 5 is a flowchart of one embodiment of a method for starting an application of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software commands, written in a programming language, for example, Java, C, or assembly. One or more software commands in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings

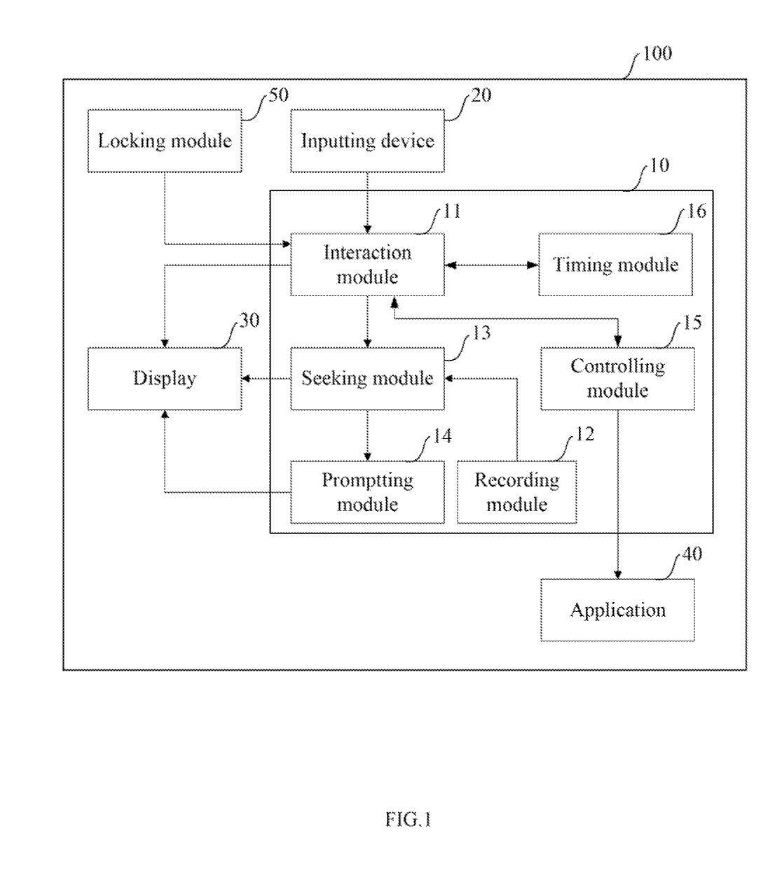

FIG. 1 is a block diagrammatic view of one embodiment of an electronic device 1 including an application starting system 10. The electronic device 1 may be a mobile phone, a tablet computer, a personal digital assistant, a notebook computer, or other computing device. The electronic device 1 further includes at least one processor (not shown), a storage (not shown), an inputting device 20, a display 30, a number of applications 40 and a locking module 50. FIG. 1 illustrates only one example of the electronic device 1 that may include more or fewer components that illustrated, or have a different configuration of the various components.

The at least one processor is used to execute the application starting system 10 and other applications, such as an operating system, installed in the electronic device 1.

The storage stores one or more programs, such as the operating system and applications of the electronic device, and stores a number of characters and a number of icons. The storage can be a storage card, such as a memory stick, a smart media card, a compact flash card, a secure digital card, or any other type of memory storage device.

The inputting device 20 is used to receive manual operation. The inputting device 20 can be a number of keys or soft keys.

The display 30 may display visible data and receive touch signals in response to touch operations.

The applications 40 are used to provide the user with tools to accomplish a count, a calendar, a game or a call.

The locking module 50 is used to determine whether a time that the user does not operate the electronic device 1 is in a predetermined range. When the time period that the user does not operate the electronic device 1 is in the predetermined range, the locking module 50 locks the screen of the electronic device 1 for controlling the electronic device 1 to enter a stand-by state. When the electronic device 1 enters the stand-by state, the locking module 50 detects a screen unlock operation inputted by the user. The locking module 50 unlocks the screen of the electronic device 1 for controlling the electronic device 1 to start work and generates an activating instruction when the screen unlock operation is inputted by the user.

The application starting system 10 includes an interaction module 11, a seeking module 13, a controlling module 13, a prompting module 14, and a timing module 15.

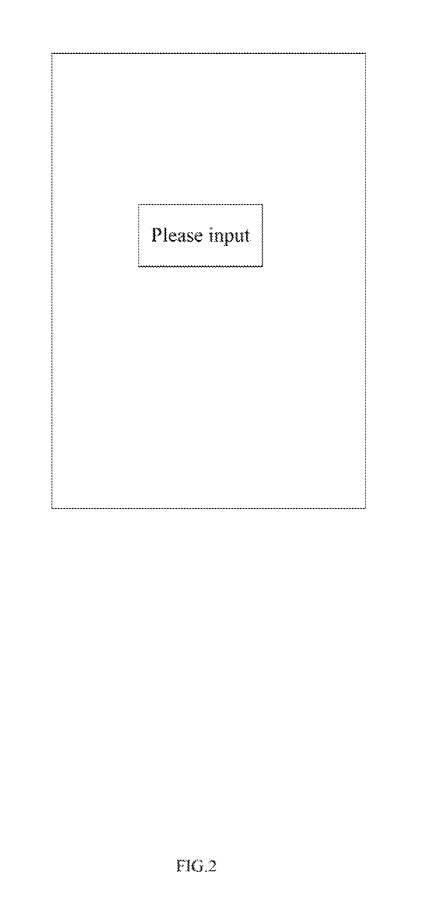

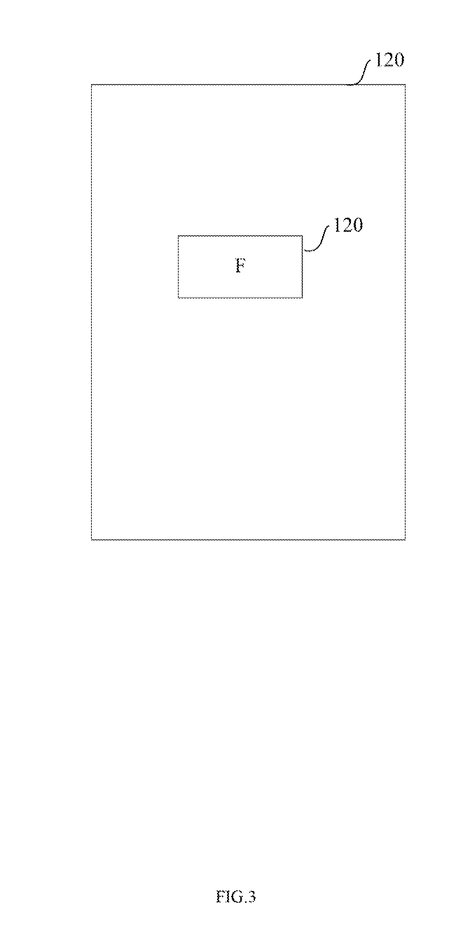

The interaction module 11 generates a first user interface in response to the activating instruction. FIGS. 2 and 3 are diagrammatic views of the screen of the electronic device 1. The first user interface 110 includes a dialog box 111 for receiving one or more characters inputted by the user. The interaction module 11 determines whether at least one character is received or not. When the at least one character is received, the interaction module 11 obtains the at least one character and generates a seeking instruction when the user inputs the one or more characters in the dialog box 111.

The recording module 12 records a number of characters each correspond to one or more applications and a number of icons each correspond to one application. The character can be a first character of the name of the applications, or can be an English character, a Chinese character or a number. When one icon is chosen, the corresponding application of the chosen icon is started.

The seeking module 13 seeks the corresponding application 60 according to the obtained character. When none of the application 60 has been sought, the seeking module 13 generates a prompting instruction. When at least one application 60 has been sought, the seeking module 13 generates an interaction instruction.

The prompting module 14 generates a message for prompting that the character is invalided and controls the display 50 to display the message.

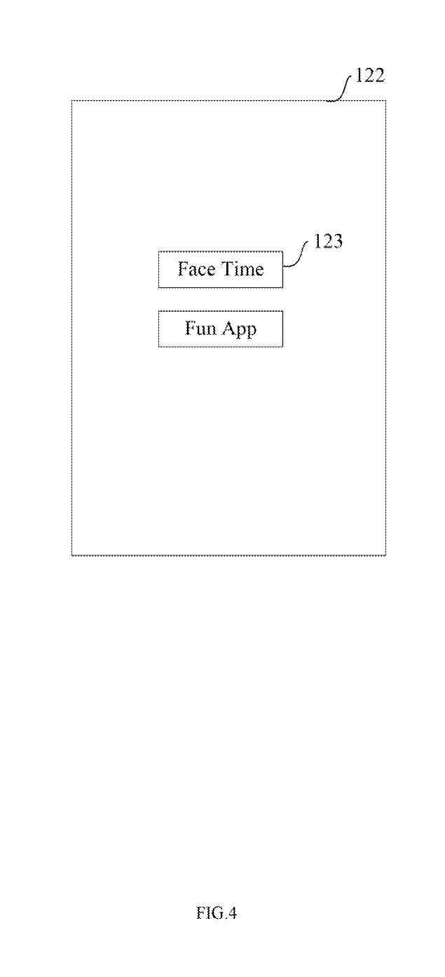

The interaction module 11 generates a second user interface and controls the display 30 to display the second user interface in response to the interaction instruction, and generates a timing instruction for controlling the timing module 16 to count a time period of the display of the second user interface. As shown in FIG. 4, the second user interface 112 includes the icon 113 of the sought corresponding application.

The interaction module 11 determines whether one icon 113 is chosen or not and whether the time period of the display of the second user interface 112 is equal to a predetermined value or not. When none of the icons 123 is chosen and the time period of the display of the second user interface 112 is equal to the predetermined value, the interaction module 11 controls the display 30 to display the first user interface 111 and generates a stop instruction. When one icon has been chosen, the interaction module 11 generates a controlling instruction and the stop instruction.

The controlling module 15 starts the corresponding application of the chosen icon 113 in response to the controlling instruction.

The timing module 16 stops to count the time period in response to the stop instruction.

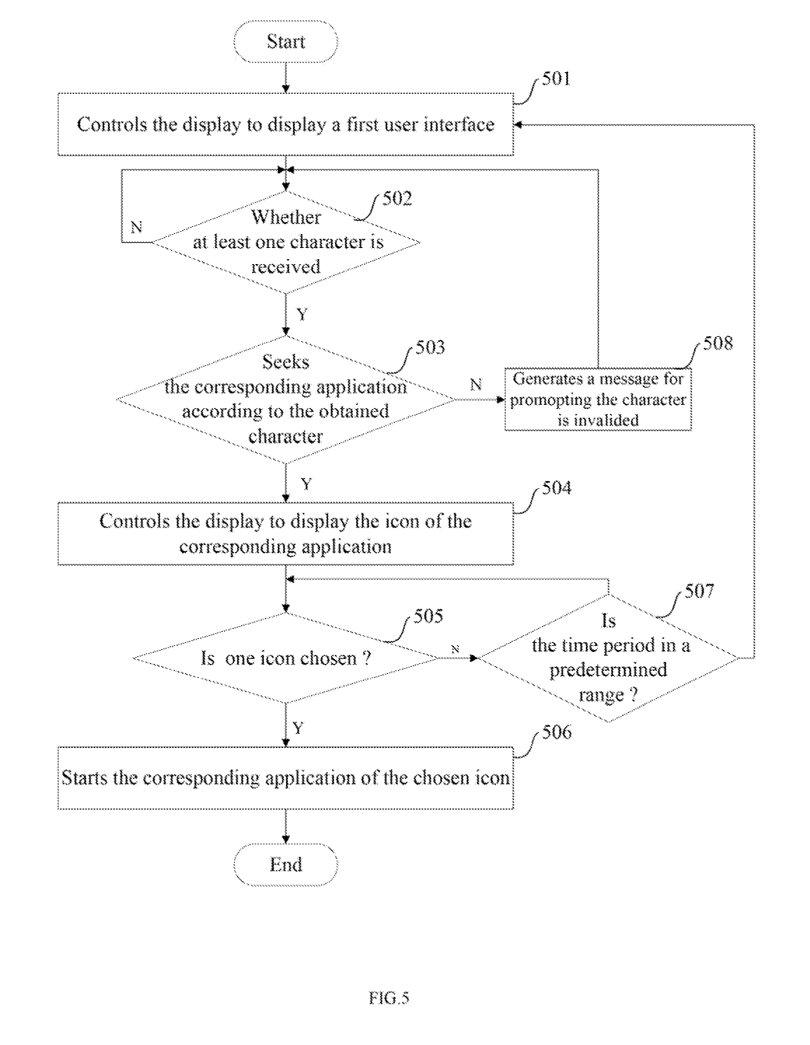

FIG. 5 illustrates an application starting method using the electronic device. Depending on the embodiment, additional steps may be added, others removed, and the ordering of the steps may be changed.

In block 501, the interaction module controls the display to display a first user interface for receiving one or more characters inputted by a user.

In block 502, the interaction module determines whether at least one character is received or not. When the at least one character is received, the block 503 is implemented. When no character is received, the block 502 is implemented.

In block 503, the seeking module seeks the corresponding application according to the obtained character. When at least one application is sought, block 504 is implemented. When none of the applications is sought, block 508 is implemented.

In block 504, the interaction module controls the display to display the icon of the sought corresponding application.

In block 505, the interaction module determines whether one icon is chosen by the user or not. When at least one icon is chosen, block 506 is implemented. When no icon is chosen, block 507 is implemented.

In block 506, the controlling module starts the corresponding application of the chosen icon.

In block 507, the interaction module determines whether a time period of display of the second user interface is equal to a predetermined value or not. When the time period of display of the second user interface is equal to the predetermined value, block 501 is implemented. When the time period of display of the second user interface is not equal to the predetermined value, block 505 is implemented.

In block 508, the prompting module generates a message for prompting that the character is invalided, block 502 is implemented.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. An electronic device, comprising:
a display;
at least one processor;
a storage device storing a plurality of applications each having an icon and a character, and storing a plurality of instructions, which when executed by the processor, causes the at least one processor to:
obtain at least one character;
seek a corresponding application according to the obtained character;
display the icon of the corresponding application in the display;
determine whether one icon is chosen or not;
start the corresponding application of a chosen icon when the icon of the corresponding application is chosen.

2. The electronic device as claimed in claim 1, wherein the at least one processor:
generates a first user interface having a dialog box for obtaining the at least one character.

3. The electronic device as claimed in claim 2, wherein the at least one processor:
locks the electronic device for entering a stand-by state and unlocks the electronic device for starting work in response to a manual operation; and
generates the first user interface when the electronic device is unlocked.

4. The electronic device as claimed in claim 1, wherein the at least one processor:
generates a second user interface for displaying the corresponding icon of the corresponding application.

5. The electronic device as claimed in claim 1, wherein the character of the application is a first character of a name of the application, wherein the at least one processor:
determines whether the obtained character matches the character of the application for seeking the at least one corresponding application in the storage.

6. An application starting method of an electronic device, comprising:
recording a plurality of applications each having an icon and a character into a storage of the electronic device;
obtaining at least one character;
seeking the corresponding application in the storage according to the obtained at least one character;
displaying the corresponding icon of the corresponding application;
determining whether one icon is chosen or not;
when one icon is chosen, starting the corresponding application of a chosen icon.

7. The application starting method as claimed in claim 6, further comprising:
generating a first user interface having a dialog box for obtaining the at least one character.

8. The application starting method as claimed in claim 7, further comprising:
locking the electronic device for entering a stand-by state and unlocking the electronic device for starting work in response to a manual operation;
generating the first user interface when the electronic device is unlocked.

9. The application starting method as claimed in claim 6, further comprising:
generating a second user interface for displaying the corresponding icon of the corresponding application.

10. The application starting method as claimed in claim 6, wherein the character of the application is a first character of a name of the application, the application starting method further comprising:
determining whether the obtained character matches the character of the application for seeking the at least one corresponding application in the storage.
